(19) United States
(12) Patent Application Publication
(10) Pub. No.: US 2012/0061014 A1
(43) Pub. Date: Mar. 15, 2012

(54) Self-Adhesive Material With A Water Soluble Protective Layer

(75) Inventors: Shilpan Pravinchandra Patel, Mumbai (IN); Bruce Michael Drew, Essex (GB)

(73) Assignee: ARROW COATED PRODUCTS LTD., Middlesex (GB)

(21) Appl. No.: 13/180,146

(22) Filed: Jul. 11, 2011

(30) Foreign Application Priority Data
Apr. 14, 2009 (GB) 2469441

(51) Int. Cl. B32B 37/14; B05D 1/36; B32B 3/10; B32B 38/00; B32B 7/12; B32B 3/00; B05D 5/10; B32B 38/08

(52) U.S. Cl. 156/192; 427/208.8; 156/443; 428/336; 428/195.1; 428/131

(57) ABSTRACT

A face material is coated with a pressure sensitive adhesive which is in turn coated with a water soluble protective layer. The opposite printed side of the face material may be coated with hydrophobic lacquer. The adhesive is dried or cooled before the protective coating is applied. The protective layer is applied by extrusion or solution casting. Alternatively a reusable liner can be coated with the protective material and adhesive before the protected adhesive is transferred onto a face material. labels made from the material can be applied by passing them through water and guide rolls, and then between punching die and two way moving vacuum cylinder, and squeeze rolls

### CROSS-REFERENCE TO RELATED APPLICATIONS

The present application is related to UK Patent Application Serial No. 2469441 filed on Apr. 14, 2009, which is herein incorporated by reference.

### STATEMENT REGARDING FEDERALLY SPONSORED RESEARCH

Not Applicable.

### BACKGROUND OF THE INVENTION

This invention relates to liner-less self-adhesive materials and processes for producing such materials.

Typical self-adhesive materials require the pressure sensitive adhesive to be protected by what is often described as a liner. In current practice, the liner typically comprises a paper or polymeric substrate siliconized on one side such that the siliconized side is laminated to the pressure sensitive adhesive, allowing the liner to be subsequently removed and discarded, exposing the pressure sensitive adhesive, ready for adhesion to an object.

The published application WO 2007/015264 has described a process for preparation of liner-less self-adhesive materials and an apparatus and a method for applying the same liner-less self-adhesive materials to an object. During the process, the web of self-adhesive material is passed through a water bath in order to dissolve the water-soluble protective layer. During the dissolution of the water-soluble protective layer, the face material will also come into contact with water which could lead to weakening of the face material, especially if the face material comprises paper or other hydrophilic material. In the present invention, the applicant has overcome this problem by coating the face material, either before or after printing, with a hydrophobic or water repellent lacquer on its upper surface.

In WO 2007/015264, the protective layer is a solution cast water-soluble substrate of thickness between 5 and 40 microns which is subsequently laminated to a face material previously coated with a pressure sensitive adhesive. Using teachings taught by this earlier invention, it has been impractical to cast a water-soluble substrate of thickness less than 5 microns due to potential formation of pin-holes in the water-soluble substrate which pin-holes can cause the self-adhesive material to block, i.e. stick to itself during unwinding. In the present invention, we describe processes for preparation of self-adhesive materials wherein the thickness of the water-soluble protective layer is reduced to between 1 and 5 microns without causing the self-adhesive material to block during unwinding. This results in faster dissolution of the water-soluble protective layer during use of self-adhesive material according to this invention, as well as lower usage of water and reduced cost of the water-soluble protective layer.

### DEFINITIONS PERTAINING TO THE INVENTION

Water Soluble Protective Layer: This shall mean water-soluble protective layer(s), however placed in position.

Face Material: This shall mean the substrate to which the pressure sensitive adhesive is applied.

Pressure Sensitive Adhesive (PSA): This shall mean any type of adhesive that adheres firmly to the desired object on application of any kind of pressure. Such adhesives may be water-based, solvent-based, hot melt, although these types are by no means limiting.

Self-Adhesive Material (SAM): This shall mean self-adhesive material wherein the pressure sensitive adhesive is protected with a water-soluble protective layer.

### BRIEF SUMMARY OF THE INVENTION

Briefly stated, the present disclosure provides a liner-less self-adhesive material in which the adhesive is protected by a water-soluble layer preferably of thickness less than 5 microns.

In at least one embodiment, the present invention provides a liner-less self-adhesive material comprising a water repellent face material coated on one side with a pressure sensitive adhesive which is protected by a water-soluble protective layer.

In preferred embodiments, the water-soluble protective layer has a thickness of less than 5 microns and comprises edible or non-edible water-soluble polymers selected for their rapid speed of dissolution.

In one aspect, the present invention provides a liner-less self-adhesive material comprising a face material having a layer of pressure sensitive adhesive on its lower surface, which adhesive is in turn protected by a water-soluble protective layer of thickness less than 5 microns.

The face material may be hydrophobic or water repellent on its upper surface. For example the upper surface may be coated with hydrophobic or water repellent material such as a lacquer so that the face material does not become weakened on contact with water during the dissolution of the water-soluble protective layer.

The face material may be coated with hydrophobic or water repellent lacquer including, but not limited to, VMCH, VYCH, poly-vinylidene chloride, acrylates, polyurethane, and epoxy resins. In post-printing processes, preferred water repellent lacquers are, but not limited to, silicones, poly-tetra-fluoro-ethylene (for example, Teflon(˜\ a registered mark of DuPont, USA), poly-vinyl fluoride (for example, Tedlar®, a registered mark of DuPont, USA), THV, a polymer of tetrafluoroethylene, hexafluoropropylene and vinylidene fluoride (for example, Dyneon@, a registered mark of 3M, USA) etc. The face material may optionally be coated on either surface.

The hydrophobic or water repellent coating may be applied prior to printing or post printing. If the coating material is applied prior to printing, the coating material is selected such that it provides good reception and good adhesion to the printing inks used. Similarly, if a post-printing process is utilized, it is preferable that the coating material should be inert to the printing ink or under printed lacquer, and water repellent, preferably water resistant, and more preferably, water proof.

The pre-printing or post-printing coating can be performed on-line or off-line. The coating material can be applied on coating machines during the process of producing the self-adhesive material or during a subsequent label printing process. Printing on the face material may be done by any suitable printing methods such as, but not limited to, gravure, flexography, dry or wet offset, inkjet printing, thermal printing, screen printing, subliminal ink printing, holographic embossing, or hot foil stamping.

The water-soluble protective layer can be placed upon the self-adhesive material by different processes including lamination of a water-soluble substrate upon the pressure sensitive adhesive or by extrusion directly upon the pressure sensitive adhesive via T-die, other extrusion methods, or by projection, although these methods are by no means limiting. With some or all of these methods, it is possible to prepare self adhesive material according to this invention by in-line sequential operations.

The water-soluble protective layer can be made of non edible or edible grade film-forming polymeric materials. Non edible materials may be selected from, but not limited to, polyvinyl alcohol copolymer ionomers, polyvinyl alcohol homopolymer, non-ionomeric poly vinyl alcohol polymer, polymethacrylate, Poly Vinyl Alcohol, polyacrylamide, polymethacrylamide, polyacrylic acid, polymethacrylic acid, polyurethane. Edible materials may be selected from, but not limited to, polyethyleneglycol, polyvinylpyrrolidone, proteinaceous binders such as gelatin, modified gelatins such as phthaloyl gelatin, polysaccharides such as starch, gum arabic, pullulan or dextrin or water-soluble cellulose derivatives such as methyl cellulose, hydroxyl propyl cellulose, hydroxyl propyl methyl cellulose, hydroxyl propyl ethyl cellulose, hydroxy ethyl cellulose or carboxyl methyl cellulose or combination thereof.

The water-soluble protective layer can be cold water soluble, warm water soluble or hot water soluble depending upon the end application. The temperature of dissolution of the water-soluble protective layer will depend upon its composition, the molecular weight of each of the polymers contained therein, and other factors.

The water-soluble protective layer can be printed, unprinted, embossed, transparent, pigmented or colored as per requirement. It can also be marked with invisible light fluorescing dyes and pigments, such as, but not limited to, ultra-violet and infra-red fluorescing dyes and pigments.

The thickness of the water soluble protective layer is less than 5 microns, preferably is not less than 1 micron and more preferably is from 2 to 3 microns.

A further layer may be provided between the pressure sensitive adhesive and the water-soluble protective layer in order to enhance release of the water soluble protective layer from the pressure sensitive adhesive. Examples of such further layer, although these are by no means limiting, are silicone coatings.

The lower surface (defined as that surface of the face material opposite to the upper surface) is adhesive coated while the upper surface will in general, but not always, be printed. The face material may be selected from, but not limited to, uncoated or coated paper, film, metal foils, fabric, ink receptive coated materials or a combination of any of these materials, and can be selected from, but not limited to, heat sensitive materials such as PVC (poly-vinyl chloride), HIPS (high impact polystyrene), LLOPE (linear low density polyethylene), heat shrinkable linear low density polyethylene, PP (polypropylene), APET (Anhydrous polyester), PETG (polyester glycol), HOPE (high density polyethylene) etc.

The above examples of face materials are by no means limiting. Heat sensitive materials may be used at temperatures ranging from 10° C. to 90° C. Heat resistant face materials such as paper, polyester film, KAPTON® film may be used, although these examples are by no means limiting. Heat resistant materials may be used at temperatures ranging from 30° C. to 250° C.

The selection of face material to be used also depends upon the properties of pressure sensitive adhesive to be coated upon it. The type of face material will also influence the process of manufacture when practicing this invention.

The pressure sensitive adhesive in this invention may include adhesives made from resins, polymers or co-polymers of acrylics, rubber, hot melt polymers, ethylene-vinyl acetate copolymers (EVA), starch, and polyurethanes, either dissolved in organic or inorganic hydrocarbon or water based solvents, or hot melt applied. Emulsified water based pressure sensitive adhesives are also covered within this definition. However, these examples are by no means limiting. The pressure sensitive adhesives may contain one or more of plasticizer(s), flowing agent(s), tackifier(s) and pigment(s).

Pressure can be applied manually or by means of pneumatic or hydraulic cylinders or any type of mechanical device.

In another aspect, the present invention provides a liner-less self adhesive material comprising a water repellent face material coated on one side with a pressure sensitive adhesive which is protected by a water-soluble layer wherein the self adhesive material is provided with guiding holes, spaced apart holes, and/or slits along its side edges for guiding the self adhesive material during the application process. This guiding of self adhesive materials can also be done by printing lines or light sensitive markings on the upper or lower surface of said self adhesive materials.

The face material, pressure sensitive adhesive and water soluble protecting layer may be the same as described above in connection with the first aspect of the invention.

In yet another aspect, the present invention relates to processes for producing the self-adhesive material according to the preceding aspects of the invention.

Suitable processes may include laminating and in-line processes for producing self-adhesive material wherein the water-soluble protective layer preferably has a thickness from 1 to 5 microns, is preferably free from pin-holes and preferably allows faster dissolution than would be the case if the water-soluble layer were thicker than 5 microns. This can be done in one pass or multiple passes, online or offline.

The process may include placing a further layer between the pressure sensitive adhesive and the water-soluble protective layer in order to enhance release of the water soluble protective layer. Examples of such further layer, although these are by no means limiting, are silicon coatings, as known to the person skilled in the art of making self-adhesive materials, in order to obtain accelerated release of the water-soluble protective layer during exposure to water.

The process may include removing the water soluble protective layer by pressurized water spray, optionally in discreet spray patterns so as to expose the adhesive only in desired areas or shapes, prior to the application of the self-adhesive material to the desired object. The water can be of varying temperature from 5° C. to 99° C., preferably from 10° C. to 70° C. and more preferably from 15° C. to 60° C.

After subjecting the self-adhesive material to pressurized water spray, the remaining, undissolved, part of the water-soluble protective layer may be dried along with the exposed pressure sensitive adhesive, before die cutting and application stages.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 illustrates the unwinding of a self-adhesive material of the present disclosure, having a water-soluble protective layer, and transport thereof past water sprayers and dryers;

FIG. 2 illustrates a flat die punching cylinder and a two-way moving vacuum cylinder provided for sucking, cutting and dispensing a label from the self-adhesive material of FIG. 1; and

FIG. 3 illustrates a rotating die-cutting cylinder and a two-way moving vacuum cylinder provided for sucking, cutting and dispensing a label from the self-adhesive material of FIG. 1.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

This invention comprises a liner-less self-adhesive material and process for producing the same, comprising face substrate, optionally coated with hydrophobic or water repellent lacquer on its upper surface, and with pressure sensitive adhesive on the lower surface. The pressure sensitive adhesive is protected with a water-soluble protective layer.

The present invention also describes specific processes for coating the pressure sensitive adhesive with a water-soluble protective layer, of thickness from 1 to 5 microns, pin-hole free and dissolving quickly in water.

The coating of face material with hydrophobic lacquer can be done pre-printing or post-printing. While choosing the hydrophobic lacquer, care is taken that the lacquer is ink-receptive with good adhesive properties to the face material.

The processes for production of improved liner-less self-adhesive material according to this invention are now described in detail. In processes A through D, a further layer may be provided between the pressure sensitive adhesive and the water-soluble protective layer in order to enhance release of the water soluble protective layer from the pressure sensitive adhesive.

A. Extrusion Casting of Water-Soluble Protective Layer Upon PSA:

1) Unwinding face material from unwinder of machine;

2) Optionally coating upper surface of the face material with hydrophobic lacquer;

3) Applying pressure sensitive adhesive to lower surface of face material;

4) Drying to remove solvent in the case of solvent-based or water-based adhesive or optionally passing through chilling cylinders in the case of a hot melt applied adhesive;

5) Extrusion casting of water soluble protective layer directly upon pressure sensitive adhesive coated surface of face material;

6) Optionally passing the face material, coated with pressure sensitive adhesive and water-soluble protective layer, through chilling cylinders; and

7) Rewinding same.

B, Solution Casting of Water-Soluble Protective Layer Upon PSA:

1) Unwinding face material from unwinder of machine;

2) Optionally coating upper surface of the face material with hydrophobic lacquer;

3) Applying pressure sensitive adhesive to lower surface of face material;

4) Drying to remove solvent in the case of solvent-based or water-based adhesive or optionally passing through chilling cylinders in the case of a hot melt applied adhesive;

5) Solution casting of water-soluble protective layer directly upon pressure sensitive adhesive coated surface of face material;

6) Drying and forming of the water-soluble protective layer;

7) Optionally passing the face material coated with pressure sensitive adhesive and water soluble protective layer through chilling cylinders; and

8) Rewinding same.

C. Extrusion Casting of Water-Soluble Protective Layer Upon Liner:

1) Unwinding liner from unwinder of machine;

2) Extrusion casting of water-soluble protective layer upon the liner and optionally passing same through chilling cylinders;

3) Applying solvent-based or hot melt applied pressure sensitive adhesive to upper surface of water-soluble protective layer;

4) Drying to remove solvent in the case of solvent-based adhesive or optionally passing through chilling cylinders in the case of a hot melt applied adhesive;

5) Unwinding face material;

6) Optionally coating upper surface of face material with hydrophobic lacquer;

7) Laminating lower surface of face material to the pressure sensitive adhesive coated surface of the water-soluble protective layer; and

8) Separating the liner and rewinding water-soluble protective layer laminated to pressure sensitive adhesive and face material 9) Rewinding liner separately for re-use.

D. Solution Casting of Water-Soluble Protective Layer Upon Liner:

1) Unwinding liner from unwinder of machine;

2) Solution casting of water-soluble protective layer upon liner;

3) Drying and forming of water-soluble protective layer;

4) Applying solvent-based or hot melt applied pressure sensitive adhesive to upper surface of water-soluble protective layer;

5) Drying to remove solvent in the case of solvent-based adhesive or optionally passing through chilling cylinders in the case of a hot melt applied adhesive;

6) Unwinding face material;

7) Optionally coating upper surface of face material with hydrophobic lacquer;

8) Laminating lower surface of face material to pressure sensitive adhesive coated surface of water-soluble protective layer;

9) Separating the liner and rewinding water-soluble protective layer laminated to pressure sensitive adhesive and face material; and

10) Rewinding liner separately for re-use.

E. Printing Process:

1) A self-adhesive material with water-soluble protective layer according to this invention and made according to processes A through D is unwound from unwinder of machine;

2) The upper surface of the self adhesive material is coated with an ink receptive hydrophobic coating;

3) Indicia or graphics are printed upon the coated upper surface of the face material;

4) Optionally the printed surface of the face material is top coated with hydrophobic lacquer; and

5) Drying and rewinding of same.

F. Hydrophobic Coating of Face Material Post Printing

1) A self-adhesive material with water-soluble protective layer according to this invention is unwound from unwinder of machine;

2) Indicia or graphics are printed upon the uncoated upper surface of the face material;

3) Extrusion casting of water resistant resins upon the printed upper surface of the face material, including resins such as, but not limited to, polyesters, polypropylenes, polyethylenes;

4) Chilling and rewinding same.

G. Label Dispenser:

1) Unwinding a printed self adhesive material according to the present invention such that the water-soluble protective layer is on the inner side while unwinding:

2) Passing the printed self adhesive web, preferably vertically, through a water bath provided with pressurized spray jets;

3) Optional zonal or discreet spraying of water so as to expose pressure sensitive adhesive in requisite area(s) only;

4) Passing self adhesive web with exposed pressure sensitive adhesive through a series of air dryers;

5) Die cutting of the self-adhesive label;

6) Application of the self adhesive label to desired object;

7) Removing waste matrix; and

8) Rewinding waste matrix.

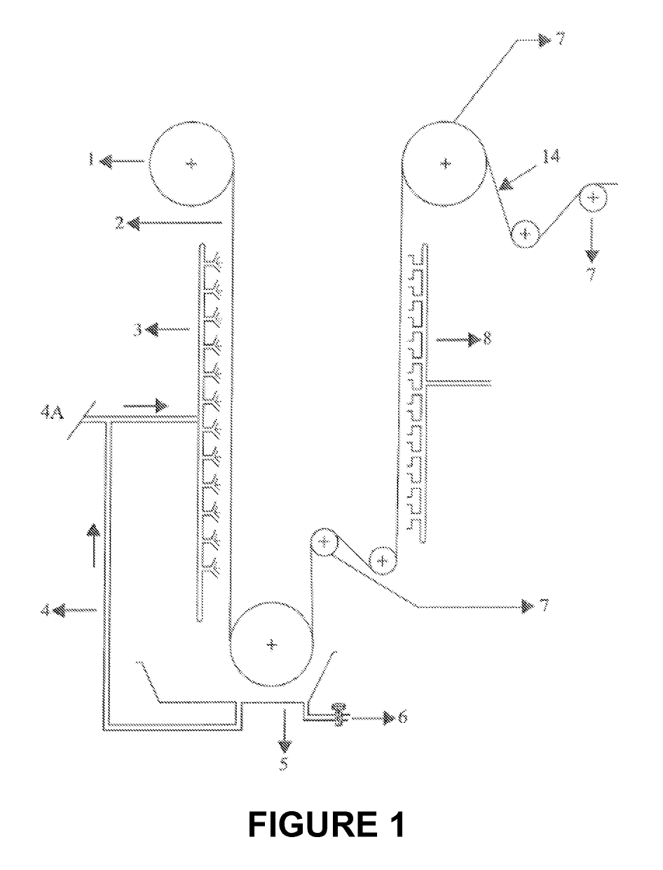

The method of applying self-adhesive material according to this invention to an object, using processes described above, is illustrated in FIGS. 1, 2 and 3 in which the affixed numbers refer to the following items:

1. Unwinding Roll

2. Self Adhesive Material Web with water-soluble protective layer

3. Water Sprayers

4. Water Connector to Inlet

5. Water Collector Tub

6. Water Outlet with Stopper

7. PTFE Roll

8. Air Dryers and Heater

9. Flat Die Punching Cylinder

10. Rotating Vacuum Cylinder and Dispenser

11. Conveyor

12. Object prior to labeling

13. Object with Label affixed

14. Self Adhesive Material with Exposed Adhesive

15. Waste Matrix Rewinding Roll

16. Rotating Die Cutting Cylinder

17. Label

With reference to FIG. 1, the method of the present disclosure includes:

1. Unwinding a Self Adhesive Material with water-soluble protective layer (2), from unwinding roll (1), such that the water-soluble protective layer will be on inner side while unwinding.

2. Water sprayed on water-soluble protective layer (2) by water sprayers (3); water is then collected in water collector tub (5), recycled through inlet connector (4), and used water purged as appropriate through outlet (6) for possible re-use of water-soluble protective polymers. Water can be refreshed as appropriate through inlet (4A). As the Self Adhesive Material with water-soluble protective layer passes through the water, the water-soluble protective layer will start dissolving and will expose part or all of the adhesive.

3. The Self Adhesive Material with exposed adhesive is then passed through a series of air dryers and heaters (8) to dry the exposed adhesive.

4. Dry Self Adhesive Material (14) with exposed adhesive is passed through PTFE rolls (7) for subsequent die cutting and application to object.

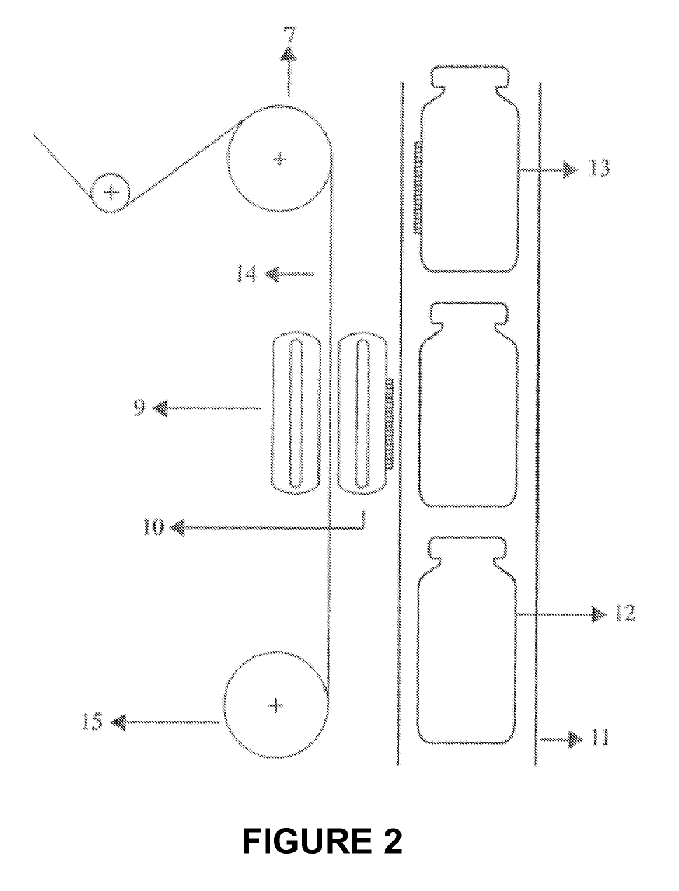

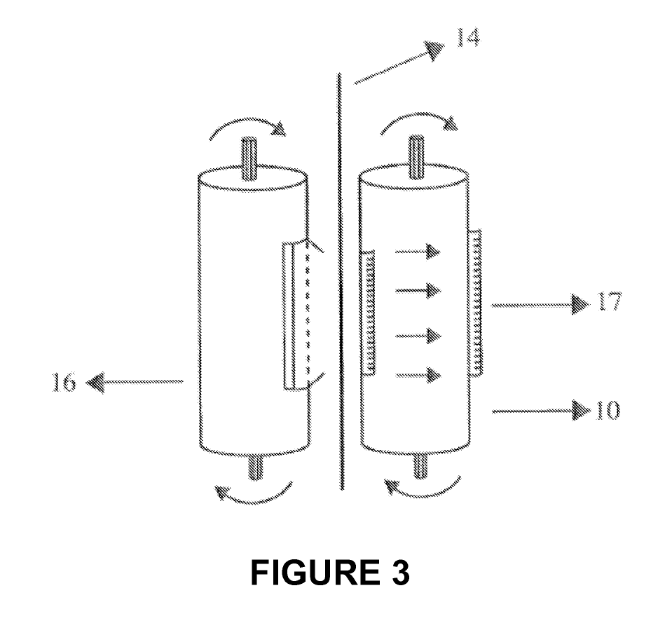

Referring to FIGS. 2 and 3:

1. Dry Self Adhesive Material with exposed adhesive (14) is either passed between a flat die punching cylinder (9) as illustrated in FIG. 2, or between a rotating die-cutting cylinder (16) and a two-way moving vacuum cylinder (10) as illustrated in FIG. 3 provided for sucking, cutting and dispensing a label.

2. In the case of the rotating system, when the Self Adhesive Material with exposed adhesive (14) arrives between the rotating die-punching cylinder (16) and the two-way moving vacuum cylinder (10) with adhesive side of the web facing the die punching cylinder (16), the vacuum cylinder (10) will suck the web (14). The vacuum cylinder (10), having the cut label (17), then rotates so that the cut label faces the conveyor (11) carrying objects to be labeled (12) and the label is then applied to an object adjacent the vacuum cylinder.

3. It should be understood that the rotating system illustrated in FIG. 3 is an alternative to the flat die-punching system shown at (9) in FIG. 2.

4. Rewinding of waste matrix at rewinder (15).

As various changes could be made in the above constructions without departing from the scope of the disclosure, it is intended that all matter contained in the above description or shown in the accompanying drawings shall be interpreted as illustrative and not in a limiting sense.

1. A self adhesive material comprising a face material coated with pressure sensitive adhesive wherein the adhesive is protected by a water-soluble protective layer of thickness less than 5 microns.

2. A self adhesive material according to claim 1, in which the face material is selected from perforated or non perforated paper, foil, fabric, polymeric materials or a combination thereof. and in which the pressure sensitive adhesive is selected from any type of adhesive made from resins or polymers or copolymers of acrylics, rubber, hot melt, ethylene-vinyl acetate copolymers, starch, polyurethane and the like which are soluble in organic or inorganic or hydrocarbon solvents or water.

3. A self adhesive material according to claim 1, in which the water-soluble protective layer comprises edible or non-edible film forming materials selected from polyvinyl alcohol copolymer ionomers, polyvinyl alcohol homopolymer, non-ionomeric polyvinyl alcohol polymer, polymethacrylate, polyvinyl alcohol, polyacrylamide, polymethacrylamide, polyacrylic acid, polymethacrylic acid or polyurethane, polyethyleneglycol, polyvinylpyrrolidone, proteinaceous binders such as gelatin, modified gelatins such as phthaloyl gelatin, polysaccharides such as starch, gum arabic, pullulan or dextrin or water soluble cellulose derivatives such as methyl cellulose, hydroxyl propyl cellulose, hydroxyl propyl methyl cellulose, hydroxyl propyl ethyl cellulose, hydroxy ethyl cellulose or carboxyl methyl cellulose or a combination thereof.

4. A self adhesive material according to claim 1, in which the face material is printed on its upper side with desired matter or graphics.

5. A self adhesive material according to claim 1 in which the self adhesive material is provided with guiding holes, spaced apart holes, and/or slits along its side edges for guiding the self adhesive material during the application process.

6. A process of preparing a self adhesive material according to claim 1 by in-line or off-line coating processes comprising the following steps:
i) Unwinding face material from unwinder of machine;
ii) Optionally coating upper surface of the face material with hydrophobic lacquer;
iii) Applying pressure sensitive adhesive to lower surface of face material;
iv) Drying to remove solvent in the case of solvent-based or water-based adhesive or optionally passing through chilling cylinders in the case of a hot melt applied adhesive;
v) Extrusion casting of water soluble protective layer directly upon pressure sensitive adhesive coated surface of face material;
vi) Optionally passing the face material, coated with pressure sensitive adhesive and water-soluble protective layer, through chilling cylinders; and
vii) Rewinding same.

7. A process of preparing a self adhesive material according to claim 1 by in-line or off-line coating processes comprising the following steps:
i) Unwinding face material from unwinder of machine;
ii) Optionally coating upper surface of the face material with hydrophobic lacquer;
iii) Applying pressure sensitive adhesive to lower surface of face material;
iv) Drying to remove solvent in the case of solvent-based or water-based adhesive or optionally passing through chilling cylinders in the case of a hot melt applied adhesive;
v) Solution casting of water-soluble protective layer directly upon pressure sensitive adhesive coated surface of face material;
vi) Drying and forming of the water-soluble protective layer;
vii) Optionally passing the face material coated with pressure sensitive adhesive and water-soluble protective layer through chilling cylinders; and
viii) Rewinding same,

8. A process of preparing a self adhesive material according to claim 1 by in-line or off-line coating processes comprising the following steps:
i) Unwinding liner from unwinder of machine;
ii) Extrusion casting of water-soluble protective layer upon the liner and optionally passing same through chilling cylinders;
iii) Applying solvent-based or hot melt applied pressure sensitive adhesive to upper surface of water-soluble protective layer;
iv) Drying to remove solvent in the case of solvent-based adhesive or optionally passing through chilling cylinders in the case of a hot melt applied adhesive;
v) Unwinding face material;
vi) Optionally coating upper surface of face material with hydrophobic lacquer;
vii) Laminating lower surface of face material to the pressure sensitive adhesive coated surface of the water-soluble protective layer;
viii) Separating the liner and rewinding water-soluble protective layer laminated to pressure sensitive adhesive and face material; and
ix) Rewinding liner separately for re-use.

9. A process of preparing a self adhesive material according to claim 1 by in-line or off-line coating processes comprising the following steps:
i) Unwinding liner from unwinder of machine;
ii) Solution casting of water-soluble protective layer upon liner;
iii) Drying and forming of water-soluble protective layer;
iv) Applying solvent-based or hot melt applied pressure sensitive adhesive to upper surface of water-soluble protective layer;
v) Drying to remove solvent in the case of solvent-based adhesive or optionally passing through chilling cylinders in the case of a hot melt applied adhesive;
vi) Unwinding face material
vii) Optionally coating upper surface of face material with hydrophobic lacquer;
viii) Laminating lower surface of face material to pressure sensitive adhesive coated surface of water-soluble protective layer;
ix) Separating the liner and rewinding water-soluble protective layer laminated to pressure sensitive adhesive and face material; and
x) Rewinding liner separately for re-use.

10. A process according to claim 6 in which the self adhesive material laminate is printed with a desired matter or graphic on the other side of the face material opposite the pressure sensitive adhesive by any of the known printing methods such as digital, gravure, flexo, offset, inkjet, thermal, screen, subliminal, holographic embossing and the like.

11. A method of applying labels made from self adhesive material according to claim 1 to an object comprising the following steps:
(i) unwinding a self adhesive material web with water-soluble protective layer from an unwinder of a label applying machine;
(ii) passing the self adhesive material web through water contained in a trough with water inlet and outlet for continuously recycling a water supply, and dissolving the water soluble protective layer while passing through the water in the trough to expose the pressure sensitive adhesive;
(iii) guiding the web with exposed pressure sensitive adhesive through guide rolls preferably coated with PTFE, between a rotating punching die cylinder and a two way moving vacuum cylinder with the adhesive side of the web facing the punching die cylinder, for simultaneously cutting and sucking of the printed label, due to negative air pressure in the vacuum cylinder;
(iv) rotating the vacuum cylinder with the adhesive side of the label facing outwards and applying the label with the aid of the positive air pressure to the object in front of the cylinder, the object passing in the vicinity of the vacuum cylinder preferably on a conveyor;
(v) applying sufficient pressure to squeeze out excess water from between the label and the object by passing the object with label applied thereon through squeeze rolls; and
(vi) rewinding the waste web matrix of the web after punching out the labels.

12. A method according to claim 11 wherein the rotating die punching cylinder is replaced by a flat bed punching die.

13. A machine for applying to an object a label or the like made from a self adhesive material according to claim 1 comprising an unwinder for unwinding a self adhesive material web, a trough with water inlet and outlet for continuously recycling a water supply, a pair of guide rolls preferably coated with PTFE for guiding the self adhesive material web with exposed adhesive after coming out of the water trough, a rotating vacuum cylinder and a rotating die cutting cylinder provided for sucking, punching and applying a label to an object, a rewinder for rewinding the waste web matrix, a conveyor for moving the object in the vicinity of the rotating vacuum cylinder, a pair of squeeze rolls provided ahead of the rotating vacuum cylinder for applying sufficient pressure to squeeze out excess water from between the label and the object and pressing the label on the object.

14. A machine according to claim 13 in which a flat bed punching die is used in place of a rotating punching die cylinder.

15. A process according to claim 7 in which the self adhesive material laminate is printed with a desired matter or graphic on the other side of the face material opposite the pressure sensitive adhesive by any of the known printing methods such as digital, gravure, flexo, offset, inkjet, thermal, screen, subliminal, holographic embossing and the like.

16. A process according to claim 8 in which the self adhesive material laminate is printed with a desired matter or graphic on the other side of the face material opposite the pressure sensitive adhesive by any of the known printing methods such as digital, gravure, flexo, offset, inkjet, thermal, screen, subliminal, holographic embossing and the like.

17. A process according to claim 9 in which the self adhesive material laminate is printed with a desired matter or graphic on the other side of the face material opposite the pressure sensitive adhesive by any of the known printing methods such as digital, gravure, flexo, offset, inkjet, thermal, screen, subliminal, holographic embossing and the like.
